(19) United States
(12) Patent Application Publication
(10) Pub. No.: US 2011/0247895 A1
(43) Pub. Date: Oct. 13, 2011

(54) Walk through ladder platform

(76) Inventor: Leon B. Smith, Louisville, KY (US)

(21) Appl. No.: 12/798,750

(22) Filed: Apr. 9, 2010

(51) Int. Cl. E06C 7/18

(52) U.S. Cl. 182/106

(57) ABSTRACT

A ladder or a retrofit kit for a ladder specially designed for a safe ascent onto and descent from a roof top. Two swing arms are mounted on the outside of the ladder rails near the top rung of the ladder. The swing arms are normally in a storage position along side the rails. The arms can be pivoted and locked in an upright or nearly upright position, forming handles to hold as a user walks through the arms and onto the roof. Each arm can have a non-slip grip covering at least half of the arm beginning at it's free end. Additionally, a swing plate is pivotally attached to the top rung. With the top rung just above the level of the roof edge, the plate or step can be pivoted over and onto the roof to create a safe step at the top of the ladder. The swing arms and safety step can be incorporated into a quick and easy to install retrofit kit which could be temporarily or permanently attached to most ladders.

### TECHNICAL FIELD

The present invention relates to the field of ladders or ladder platforms or extensions which are intended to improve the safety of a user.

### DESCRIPTION OF THE RELATED ART

Ladders with extended rails at the top are well known in the art. Attachable rail extensions are also known. U.S. Pat. No. 7,322,442 B2 by Clark et al. issued on Jan. 29, 2008 teaches walk through side bar extensions which are attached to the top portion of the rails in a variety of ways including bolts, clamps, sliding hooks and the like. U.S. Pat. No. 5,941,343 by Kelsey issued on Aug. 24, 1999 teaches vertical hand rail extensions which attach to the ladder by sliding over the top of the ladder side rails in a telescoping fashion and are secured thereto by pins or bolts providing extension arms attached with brackets to the top portion of the ladder and supported on a roof by feet for extra stability.

### BACKGROUND OF THE INVENTION

A ladder is typically used to reach high locations on buildings and other structures and particularly used to gain access to the roof of such structures. The common ladder is made up of longitudinal rails with rungs disposed therebetween along the longitudinal length of the rails whereby the ladder legs rest on the ground and the top portion is extended to lean against a roof or other supporting member at an angle of about 75 degrees (typically providing a ratio of about a 4:1 vertical to horizontal distance). Two or more ladder sections can be combined and co-operatively engaged to form an extension ladder. An extension ladder makes it possible for a person to reach higher areas of a structure with a ladder that can be extended to nearly twice its length.

Thus, because of a ladder's design, the upper end is inherently prone to slipping caused by even the slightest movement by one positioned on the upper part of the ladder, especially when the angle of inclination is close to vertical.

In addition, using a ladder to access a roof poses other problems. Oftentimes, a ladder is just tall enough to reach the edge of a roof. Typically, and in accordance with governmental safety regulations, the upper most part of the ladder must extend above the edge of the roof so that a person can adequately step onto the roof. The Occupational Safety and Health Administration in 29 C.F.R. Section 1926.1053(b)(1) specifies that where portable ladders are used for access to an upper landing surface, the ladder side rails shall extend at least three feet above the upper landing surface to which the ladder is used to gain access.

In order for a person to access the roof when exiting a typical ladder, he must climb around one of the side rails of the ladder, which creates a situation where the ladder will likely be pushed away from the user and possibly fall away from the roof. In addition, the safety of the person can be compromised at that moment, since the person may rely on the ladder rails to hang onto while stepping from the ladder onto the roof.

These conditions also occur when a person is merely using the ladder to reach high locations. For example, when using a ladder on a typical residential house, the upper most part of the ladder is typically leaned against the outer edge of the gutter. Besides the fact that a ladder is likely to slip against the edge of a gutter, gutters are typically not rigid enough to give good support to a ladder and its user.

### SUMMARY OF THE INVENTION

The present invention provides extension arms which are permanently and pivotally attached to the outer sides of the rails of the ladder at a point close to the top rung. At the top of the ladder, the user can swing each of the arms into one of a plurality of positions, typically to a point where the arms are nearly vertical and then lock the arms into place. The arms can be provided with non-slip grips to enhance a users grip during climbing.

Additionally, a step plate is pivotally connected to the top rung such that with the top rung just above the edge of the roof, the plate can be pivoted over and rests on the roof, thus providing a generally horizontal safety step or platform which also tends to hold the ladder from slipping as the user walks through the arms or side rails of the platform and off onto the roof or other structure. Another advantage provided by the step plate is that is covers the gutter. This protects the gutter from being stepped on but more importantly protects the user from stumbling on the gutter and possibly falling. In order to allow the step plate to be level when it is pivoted down onto an elevated surface, it's length may be adjustable. For example, it may be composed of two plates held together with screws in long slots or nested one within the other which allow the plates to telescope and extend the length with respect to one another.

Further, the bottom outer edge of the step plate where the plate comes into contact with the roof can have a non-skid coating which would help prevent slippage of the entire ladder relative to the roof.

At least one preferred embodiment of the present invention comprises, consists essentially of or consists of a ladder used to gain access to an elevated surface by inclining the ladder against an outer edge of the surface. The ladder has a pair of laterally spaced apart rails interconnected by vertically spaced apart rungs, and includes a pair of rotary units pivotally attached on an outer side of a top portion of the rails. Each of the rotary units have an arm member fixed to the rotary unit extending outward from the rotary unit and parallel to the rails. the rotary units are capable of being locked in any of several selected positions. One of the positions causes the arms to be held in a storage/transport position. Another of the positions causes the arms to be held in an upright position for providing a walk through passageway providing safe ascent to and descent from the elevated surface. A step plate is hingedly attached to a top rung of the ladder wherein the step plate can be held in a storage/transport position or can be swung down onto the elevated surface to provide a safety step.

Another embodiment of the present invention comprises, consists essentially of or consists of a safety accessory kit for a ladder used to gain access to an elevated surface by inclining the ladder against an outer edge of the surface. The ladder has a pair of laterally spaced apart rails interconnected by vertically spaced apart rungs. The kit includes a pair of ladder rail engaging members configured to slidably receive a top portion of the rails. The members have formed therein a slot for slidably receiving a top rung of the ladder and the members including a rotary unit having an arm member fixed to the rotary unit and extending outward from the rotary unit and parallel to the rails. The rotary units are capable of being locked in any of several selected positions. One of the positions causes the arms to be held in a storage/transport position. Another of the positions cause the arms to be held in an upright position for providing a walk through passageway providing safe ascent to and descent from the elevated surface. A step plate is configured to be hingedly attached to a top rung of the ladder wherein the step plate can be held in a storage/transport position or can be swung down onto the elevated surface to provide a safety step. At least two hinge assemblies are provided for hingedly attaching the step plate to the top rung of the ladder.

It is an object of the present invention to provide a ladder which provides a safe way of ascending onto and descending from the roof of a structure.

It is an object of the present invention to provide an extension accessory for a ladder which pivots down to a storage and transport position and pivots up and locks into an approximately vertical position to provide arms and handles which a user can walk through safely onto a selected surface.

It is also an object of the present invention to provide a non-skid step plate which pivots on the top rung of a ladder onto a roof edge to provide stability to the ladder and to protect gutters.

It is another object of the present invention to provide a walk through ladder apparatus that is inexpensive to produce.

It is another object of the present invention to provide a ladder safety apparatus that is reliable even after rigorous and extended use.

### BRIEF DESCRIPTION OF THE DRAWINGS

A better understanding of the present invention will be had upon reference to the following description in conjunction with the accompanying drawings in which like numerals refer to like parts throughout the views wherein:

FIG. 1 is an oblique view of a ladder with swing arm and step plate in storage/transport position.

FIG. 2 is a side view of a ladder leaning against a gutter with the step and swing arm in position to be used.

FIG. 3 is a partial side view showing the ladder rail and top rung with a step pivotally attached.

FIG. 4 is a partial oblique view of the top portion of a ladder with swing arm up and locked and step down and engaging the roof surface.

FIG. 5 is an oblique left side view of a retrofit swing arm for a left rail.

FIG. 6 is a cross-sectional view of a rotary unit which allows the arm to swing and to lock into position.

FIG. 7 is an oblique view of the present invention wherein the swing arms are bent to provide a wider walk through passage.

FIG. 8 is an oblique right side view of retrofit swing arm for a left rail.

FIG. 9 is a partial side view of a step plate with a U-bracket hinge attached.

FIG. 10 is a cross-sectional view of a rotary unit wherein a pin is placed in a selected aperture within both disks to lock the rotary unit.

FIG. 11 shows the disk fastened to a ladder rail and containing multiple apertures.

FIG. 12 is a partial view of a rotary unit wherein the rotating disks contain interlocking teeth.

### DESCRIPTION OF THE PREFERRED EMBODIMENTS

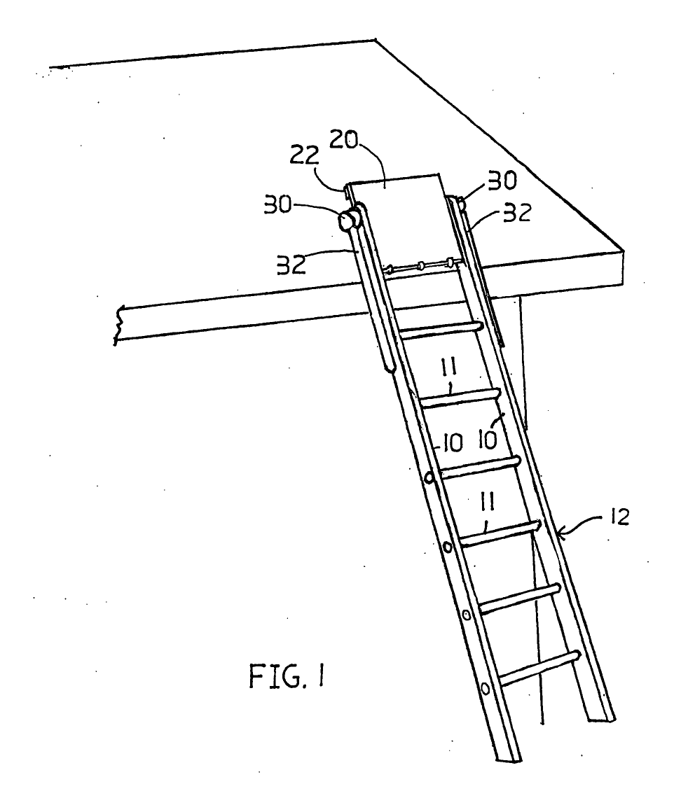

In accordance with the present invention, there is provided a ladder 12 with a walk through top portion having a pair of pivoting arms 32 extending from the distal ends of the ladder rails 10 providing selectively angled holding rails and a safety step plate 20 pivotally attached to the top rung 14 of the ladder 12. FIG. 1 shows ladder 12 comprising a pair of laterally spaced apart rails 10, each having an upper portion and a lower portion. Rails 10 are interconnected by laterally extending rungs 11.

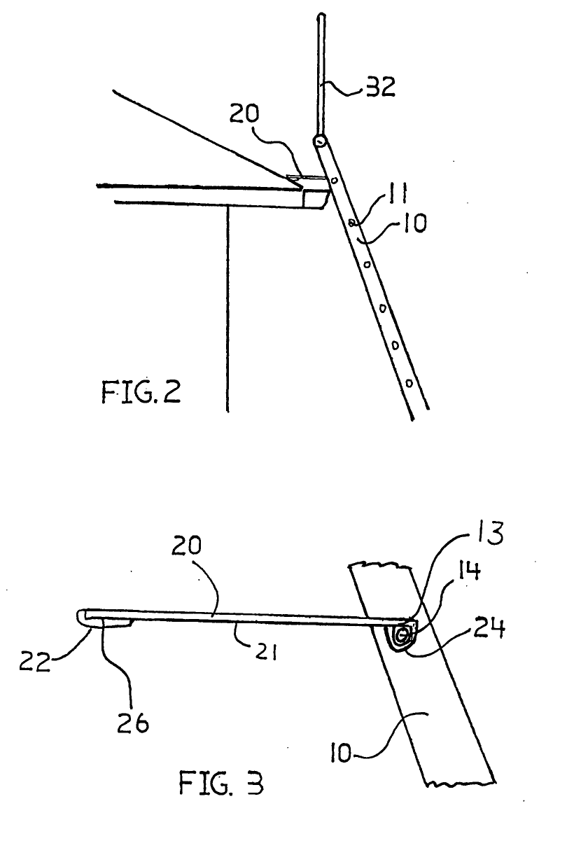

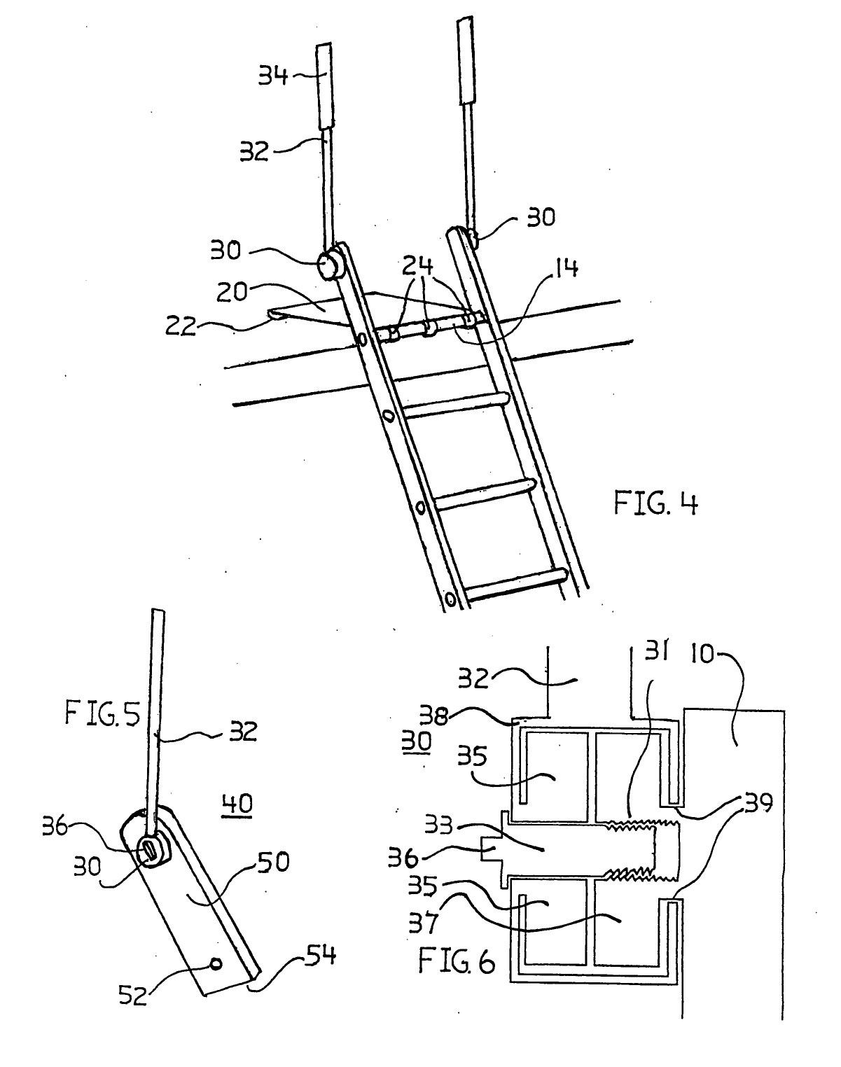

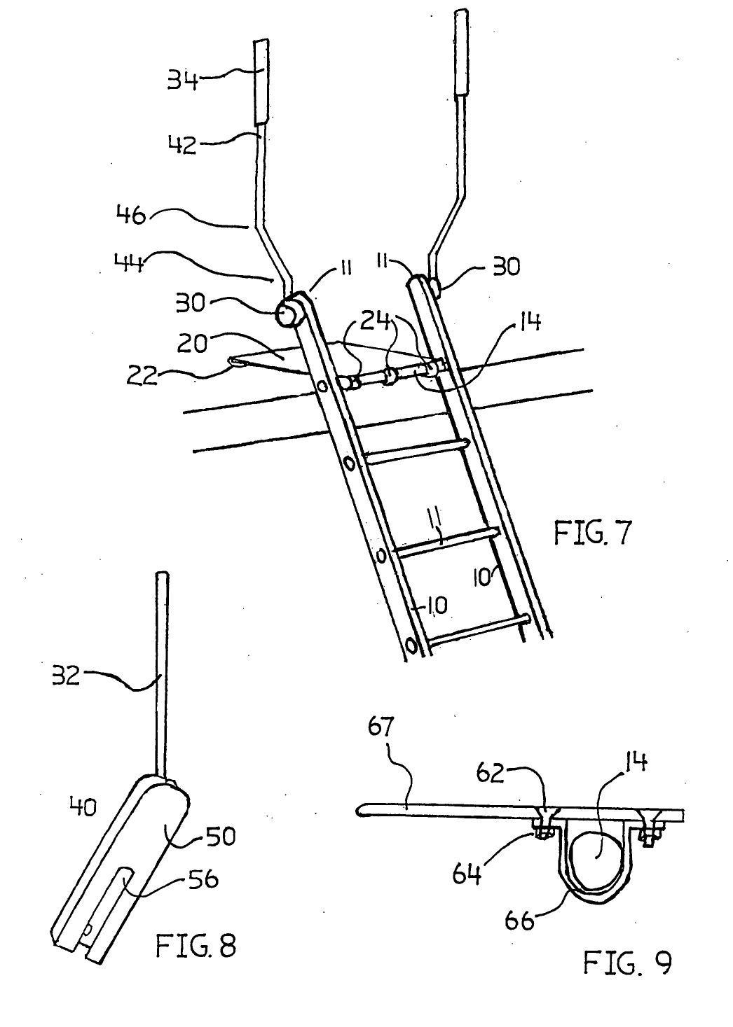

As illustrated in FIGS. 1-12, a rotary locking unit 30 attached to the side of each one of a pair of rails 10 near the top distal end 11. A pair of swing arms 32 defining hand rails attach to an outer peripheral side of an opposing rotary locking units 30. Non-slip grips 34 are fixedly attached to swing arms 30. A substantially flat planar member or plate 20 defining a safety step is pivotally attached to a top rung 14 of the ladder 12 and extends between the rails 10. Hinge means defining “C” shaped clamps 24 extend from a rear distal edge 13 of the plate 20 encircling or surrounding rung 14 in a rotating manner as shown best in FIG. 3. A non skid pad 22 is fixedly attached to a selected area such as the outer edge 26 or selected points along the outer edge 26 of plate 20 at least along the bottom surface 21 to prevent slippage of plate 20 during use. As best shown in FIGS. 3 and 7, the pad is mounted to the underside surface 21.

Rotary locking units 30 supporting the swing arms 32 include interlocking rotating disks. Disk 37 is attached to rail 10 and disk 35 is attached to the housing 38 which is also attached to the swing arm 32. A means for tightening and locking defining a threaded bolt 36 cooperatively engaging a threaded bore extending through the discs 35, 37 and engaging a rail 10 of the ladder 12 or a frame or housing secured to the ladder rail 10 is used to bias disk 35 and disk 37 together in a cooperative engagement position such that one disk cannot rotate with respect to the other. Therefore, swing arm 30 cannot rotate relative to rail 10. Moreover, if desired the swing arm 32 on one side of the ladder can be positioned at a different from that of the opposing swing arm 32 allowing the swing arm to be used as an additional support and or stabilizing member in contact with the roof or other support structure.

FIG. 6 shows the distal end of the swing arm 32 extending from a housing 38 of a rotary unit 30 which is affixed to disk 35. Disk 37 is affixed to rail 10 by a bolt or bracket or frame member secured to rail 10. Housing 38 will rotate on surface 39 at the junction of disk 37 and rail 10. The handle 36 turns a bolt 33 which urges disk 35 against disk 37 to clamp each to the other. The mating surfaces of disks 35 and 37 optionally include friction enhancing means comprising grit surfaces, irregular surfaces, teeth, notches, lines, or combinations thereof which mate and cooperatively engage one another or any other surface features that may help lock one disk to the other.

FIGS. 5 and 8 show retrofit unit 40 containing rotary locking unit 30, swing arm 32 mounted onto sleeve 50. A portion of the rotary unit housing 38 can be integrally formed as a portion of the sleeve 50 which is hollow and shaped to receive the top portion of a rail inserted through receiving end 54. Housing 50 includes slot 56 to receive rung 14 as it is slipped down over the top portion of rail 10 as shown in FIG. 8. A pin or bolt may be inserted into aperture 52 and through a properly placed aperture in the rail to lock unit 40 into place. A step plate 67 may be retrofit onto top rung 14 of a ladder to complete the retrofit assembly by using screw 62 and nut 64 combinations to fasten U-bracket 66 to step plate 67, wherein U-bracket 66, step plate 67 and rung 14 function as a hinge, as shown in FIG. 9.

Another embodiment of the present invention, shown in FIG. 7 contains swing arms 42 with two bends 44 and 46 forming an S-curve near the rotary units 30, thus providing a wider walk through passageway.

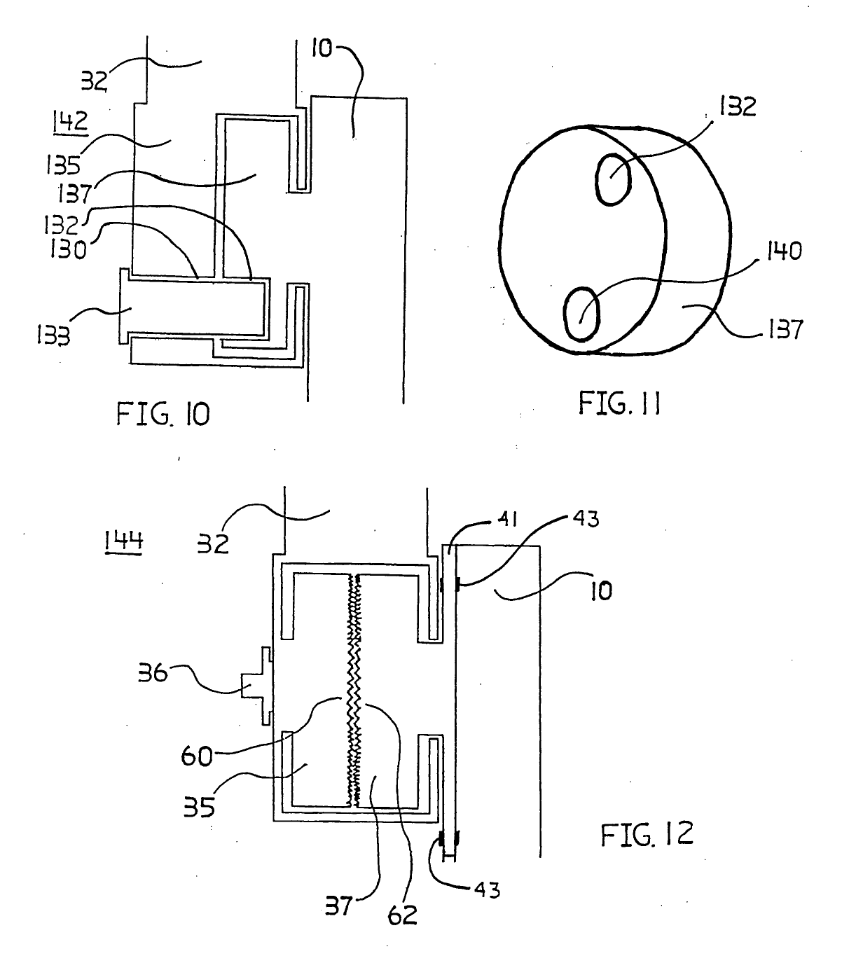

A further embodiment, shown in FIG. 10, has rotary unit 142 which contains disk 137 with apertures 132 and 140, as shown in FIG. 11. Disk 135 contains aperture 130. When swing arm 32 is rotated to the upward position, pin 133 is inserted into aperture 130 and aperture 132, to lock the arm in position. However, when the arm in the transport position, aperture 130 now aligns with aperture 140 and pin 133 is now inserted into them to lock the arm into transport position.

Another embodiment shown in FIG. 12, has disks 35 and 37 with interlocking teeth 60 and 62, on their interfacing sides. As bolt 36 is tightened, disk 35 is urged toward disk 37 and therefore, teeth 60 are urged into mesh with teeth 62, thus locking arm 32 into position. Also shown is the stationary base disc 37 removably attached to rail 10 by a plate 41 mounted thereto by holding means such as bolts, rivets, clamps etc.

It is desirable that step 123 is level when using it to enter a roof or high level surface. This is made possible by making the length of step plate 123 adjustable. Another embodiment features the adjustable step plate 123 whose length is adjustable. With screws 125 loosened, plate 127 may slide toward plate 124 to shorten step 123, or it may slide away from plate 124 to lengthen step 123. Slots 129 allow sliding of screws 125. Screws 125 are tightened into nuts 128 to lock step plate 123 at a selected length. It is anticipated that threaded holes within plate 127 could replace nuts 128.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplification presented herein above. Rather, what is intended to be covered is within the spirit and scope of the appended claims.

I claim:

1. A walk through ladder used to gain access to an elevated surface by inclining said ladder against an outer edge of said surface, comprising:
a pair of laterally spaced apart rails interconnected by vertically spaced apart rungs, comprising:
rotary units pivotally attached on an outer side of a top portion of said rails, each of said rotary units having an arm member fixed to said rotary unit and extending outward from said rotary unit and parallel to said rails, said rotary units capable of being locked in any of a plurality of selected positions, one of said positions causing said arms to be held in a storage/transport position, another of said positions causing said arms to be held in an upright position for providing a walk through passageway providing safe ascent to and descent from said elevated surface; and
a step plate hingedly attached to a top rung of said ladder wherein said step plate can be held in a storage/transport position or can be swung down onto said elevated surface to provide a safety step.

2. The walk through ladder described in claim 1 wherein non-slip material is fixed onto the free ends of said arm members.

3. The walk through ladder described in claim 1 wherein the top surface of said step plate is covered with a non-slip material or coating.

4. The walk through ladder described in claim 1 wherein said step plate comprises deck plate.

5. The walk through ladder described in claim 1 wherein the free outer edge and the bottom surface of said free outer edge of said step plate which comes into contact with said elevated surface have applied thereon a non-slip material.

6. The walk through ladder described in claim 1 wherein said arm members contain bends forming an S-curve near said rotary units for broadening said walk-through passageway providing safe ascent to and descent from said elevated surface.

7. The walk through ladder described in claim 1 wherein said rotary units contain a first disk fixed onto said rail member which interfaces coaxially with a second disk which is fixed onto said swing arm, said first and second disks having interlocking teeth on the interfacing sides thereof and said first disk capable of being urged against said second disk by an axially inserted bolt member.

8. The walk through ladder described in claim 1 wherein said rotary units contain a first disk fixed onto said rail member and interfaces coaxially with a second disk which is fixed onto said swing arm, said first disk having an aperture formed therethrough, said second disk having two apertures formed therethrough, whereby a pin may be inserted into said aperture in said first disk and one of said apertures in said second disk, thus locking said swing arm into said storage/transport position and said pin may be inserted into said aperture in said first disk and the other of said apertures in said second disk, thus locking said swing arm into said walk-through position.

9. The walk through ladder described in claim 1 wherein said step plate is capable of having its length adjusted.

10. A safety accessory kit for a ladder used to gain access to an elevated surface by inclining said ladder against an outer edge of said surface, said ladder having a pair of laterally spaced apart rails interconnected by vertically spaced apart rungs, said kit comprising:
a pair of ladder rail engaging members for slidably receiving a top portion of said rails, said members having formed therein a slot for slidably receiving a top rung of said ladder, said members having formed therein an aperture through which a pin is passed, said pin also passing through a mating aperture formed within said top portion of said rail;
two rotary units, each pivotally mounted on each of said rail engaging members, each of said rotary units having an arm member fixed to said rotary unit and extending outward from said rotary unit and parallel to said rails, said rotary units capable of being locked in any one of a plurality of selected positions, one of said positions causing said arms to be held in a storage/transport position, and another of said positions causing said arms to be held in an upright position for providing a walk-through passageway providing safe ascent to and descent from said elevated surface;
a step plate configured to be hingedly attached to a top rung of said ladder wherein said step plate can be held in a storage/transport position or can be swung down onto said elevated surface to provide a safety step; and
at least two hinge assemblies for hingedly attaching said step plate to said top rung of said ladder.

11. The safety accessory kit for a ladder in claim 10 wherein said step plate has formed therein apertures for receiving fasteners to hold a hinge assembly.

12. The safety accessory kit for a ladder in claim 11 wherein said hinge assembly comprises:
U-brackets configured to receive said top rung of said ladder; and
fasteners for connecting said U-brackets to said step plate.

13. The safety accessory kit for a ladder in claim 10 wherein a non-slip material is fixed onto the free ends of said arm members.

14. The safety accessory kit for a ladder in claim 10 wherein the top surface of said step plate is covered with a non-slip material or coating.

15. The safety accessory kit for a ladder in claim 10 wherein said step plate comprises deck plate.

16. The safety accessory kit for a ladder in claim 10 wherein the free outer edge and bottom surface of said outer edge of said step plate which come into contact with said elevated surface have a non-slip material applied thereto.

17. The safety accessory kit for a ladder in claim 10 wherein said arm members contain bends forming an S-curve near said rotary units for broadening said walk through passageway providing safe ascent to and descent from said elevated surface.
